(19) United States
(12) Patent Application Publication
(10) Pub. No.: US 2025/0159665 A1
(43) Pub. Date: May 15, 2025

(54) RESOURCE ALLOCATION FOR UPLINK TRAINING OF USER EQUIPMENT HARDWARE COMPONENTS

(71) Applicant: QUALCOMM Incorporated, San Diego, CA (US)

(72) Inventor: Akash KUMAR, Hyderabad (IN)

(21) Appl. No.: 18/510,417

(22) Filed: Nov. 15, 2023

(51) Int. Cl. H04W 72/0453; H04L 5/00

(52) U.S. Cl. CPC H04W 72/0453; H04L 5/0053

(57) ABSTRACT

Methods, systems, and devices for wireless communication are described. A user equipment (UE) may receive, from a network entity, first signaling allocating a first set of resources for uplink response training of one or more hardware components of the UE. Further, the UE may perform, via the first set of resources and based on the first signaling, the uplink response training and transmit, to the network entity and via a second set of resources, second signaling in accordance with one or more transmission characteristics that are based on the uplink response training.

### FIELD OF TECHNOLOGY

The following relates to wireless communication, including resource allocation for uplink training of user equipment (UE) hardware components.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Devices capable of wireless communication (e.g., UEs) may include a radio frequency chain. A radio frequency chain may allow a device to transform baseband signals into radio frequency signals and may include multiple hardware components such as a power amplifier, a duplexer, filters, an antenna, etc.

### SUMMARY

The described techniques relate to improved methods, systems, devices, and apparatuses that support resource allocation for uplink training of user equipment (UE) hardware components. The method may include a UE receiving, from a network entity, first signaling allocating a first set of resources for uplink response training of one or more hardware components that make up a radio frequency chain of the UE. Further, the UE may perform, via the first set of resources and based on the first signaling, the uplink response training of the one or more hardware components. Additionally, the UE may transmit, to the network entity and via a second set of resources, second signaling in accordance with one or more transmission characteristics that are based on the uplink response training. The methods as described herein may decrease or eliminate latencies associated with other methods. For example, the methods as described herein may decrease latency associated with manufacturing of the UE.

A method for wireless communications by a UE is described. The method may include receiving, from a network entity, first signaling allocating a first set of resources for uplink response training of one or more hardware components of the UE, the one or more hardware components including a radio frequency chain of the UE, performing, via the first set of resources and based on the first signaling, the uplink response training of the one or more hardware components of the UE, and transmitting, to the network entity and via a second set of resources, second signaling in accordance with one or more transmission characteristics, the one or more transmission characteristics based on the uplink response training.

A UE for wireless communications is described. The UE may include one or more memories storing processor executable code, and one or more processors coupled with the one or more memories. The one or more processors may individually or collectively operable to execute the code to cause the UE to receive, from a network entity, first signaling allocating a first set of resources for uplink response training of one or more hardware components of the UE, the one or more hardware components including a radio frequency chain of the UE, perform, via the first set of resources and based on the first signaling, the uplink response training of the one or more hardware components of the UE, and transmit, to the network entity and via a second set of resources, second signaling in accordance with one or more transmission characteristics, the one or more transmission characteristics based on the uplink response training.

Another UE for wireless communications is described. The UE may include means for receiving, from a network entity, first signaling allocating a first set of resources for uplink response training of one or more hardware components of the UE, the one or more hardware components including a radio frequency chain of the UE, means for performing, via the first set of resources and based on the first signaling, the uplink response training of the one or more hardware components of the UE, and means for transmitting, to the network entity and via a second set of resources, second signaling in accordance with one or more transmission characteristics, the one or more transmission characteristics based on the uplink response training.

A non-transitory computer-readable medium storing code for wireless communications is described. The code may include instructions executable by one or more processors to receive, from a network entity, first signaling allocating a first set of resources for uplink response training of one or more hardware components of the UE, the one or more hardware components including a radio frequency chain of the UE, perform, via the first set of resources and based on the first signaling, the uplink response training of the one or more hardware components of the UE, and transmit, to the network entity and via a second set of resources, second signaling in accordance with one or more transmission characteristics, the one or more transmission characteristics based on the uplink response training.

Some examples of the method, UEs, and non-transitory computer-readable medium described herein may further include operations, features, means, or instructions for receiving, from the network entity, third signaling indicating one or more radio frequency requirements for the UE, where the UE performs the uplink response training without applying at least one radio frequency requirement of the one or more radio frequency requirements.

In some examples of the method, UEs, and non-transitory computer-readable medium described herein, the one or more radio frequency requirements include a threshold uplink power, a threshold signal quality value, a threshold amount of out-of-band emission, a threshold amount of in-band emission, or a combination thereof.

In some examples of the method, UEs, and non-transitory computer-readable medium described herein, the first signaling includes one or more bits and logic values of the one or more bits indicate that the first set of resources may be for the uplink response training.

Some examples of the method, UEs, and non-transitory computer-readable medium described herein may further include operations, features, means, or instructions for transmitting third signaling indicating a capability of the UE to perform the uplink response training, where receiving the first signaling may be based on the capability of the UE to perform the uplink response training.

In some examples of the method, UEs, and non-transitory computer-readable medium described herein, receiving the first signaling may include operations, features, means, or instructions for receiving the first signaling allocating the first set of resources and a third set of resources for the uplink response training of the one or more hardware components of the UE and receiving third signaling activating the first set of resources for the uplink response training, where performing the uplink response training via the first set of resources may be based on the third signaling.

In some examples of the method, UEs, and non-transitory computer-readable medium described herein, the first signaling includes radio resource control (RRC) signaling and the second signaling includes downlink control information (DCI) or a medium access control control element (MAC-CE).

In some examples of the method, UEs, and non-transitory computer-readable medium described herein, the first set of resources includes time resources, frequency resources, or both.

In some examples of the method, UEs, and non-transitory computer-readable medium described herein, receiving the first signaling may include operations, features, means, or instructions for receiving a periodicity associated with the first set of resources, the periodicity including a number of slots or a number of symbols, where performing the uplink response training via the first set of resources may be based on the periodicity.

Some examples of the method, UEs, and non-transitory computer-readable medium described herein may further include operations, features, means, or instructions for transmitting third signaling requesting resources for the uplink response training based on a trigger condition being satisfied, where receiving the first signaling may be based on the third signaling.

In some examples of the method, UEs, and non-transitory computer-readable medium described herein, the trigger condition includes an operating temperature of the UE being above a threshold, a change in operating frequency, or a combination thereof.

In some examples of the method, UEs, and non-transitory computer-readable medium described herein, performing the uplink response training may include operations, features, means, or instructions for monitoring, while transmitting uplink signaling, a performance metric of a power amplifier of the UE, where transmitting the second signaling according to the one or more transmission characteristics includes and performing a digital pre-distortion operation on the second signaling based on the performance metric indicating that the power amplifier may be operating in a non-linear manner.

In some examples of the method, UEs, and non-transitory computer-readable medium described herein, the one or more hardware components includes an amplifier, a duplexer, an antenna, a filter, an attenuator, a detector, a mixer, or a combination thereof.

A method for wireless communications by a network entity is described. The method may include transmitting, to a UE, first signaling allocating a first set of resources for uplink response training of one or more hardware components of the UE, the one or more hardware components including a radio frequency chain of the UE and receiving, from the UE and via a second set of resources, second signaling in accordance with one or more transmission characteristics, the one or more transmission characteristics based on the uplink response training.

A network entity for wireless communications is described. The network entity may include one or more memories storing processor executable code, and one or more processors coupled with the one or more memories. The one or more processors may individually or collectively operable to execute the code to cause the network entity to transmit, to a UE, first signaling allocating a first set of resources for uplink response training of one or more hardware components of the UE, the one or more hardware components including a radio frequency chain of the UE and receive, from the UE and via a second set of resources, second signaling in accordance with one or more transmission characteristics, the one or more transmission characteristics based on the uplink response training.

Another network entity for wireless communications is described. The network entity may include means for transmitting, to a UE, first signaling allocating a first set of resources for uplink response training of one or more hardware components of the UE, the one or more hardware components including a radio frequency chain of the UE and means for receiving, from the UE and via a second set of resources, second signaling in accordance with one or more transmission characteristics, the one or more transmission characteristics based on the uplink response training.

A non-transitory computer-readable medium storing code for wireless communications is described. The code may include instructions executable by one or more processors to transmit, to a UE, first signaling allocating a first set of resources for uplink response training of one or more hardware components of the UE, the one or more hardware components including a radio frequency chain of the UE and receive, from the UE and via a second set of resources, second signaling in accordance with one or more transmission characteristics, the one or more transmission characteristics based on the uplink response training.

Some examples of the method, network entities, and non-transitory computer-readable medium described herein may further include operations, features, means, or instructions for transmitting, to the UE, third signaling indicating one or more radio frequency requirements for the UE.

In some examples of the method, network entities, and non-transitory computer-readable medium described herein, the one or more radio frequency requirements include a threshold uplink power, a threshold signal quality value, a threshold amount of out-of-band emission, a threshold amount of in-band emission, or a combination thereof.

In some examples of the method, network entities, and non-transitory computer-readable medium described herein, the first signaling includes one or more bits and logic values of the one or more bits indicate that the first set of resources may be for the uplink response training.

Some examples of the method, network entities, and non-transitory computer-readable medium described herein may further include operations, features, means, or instructions for receiving third signaling indicating a capability of the UE to perform the uplink response training, where transmitting the first signaling may be based on the capability of the UE to perform the uplink response training.

In some examples of the method, network entities, and non-transitory computer-readable medium described herein, transmitting the first signaling may include operations, features, means, or instructions for transmitting the first signaling allocating the first set of resources and a third set of resources for the uplink response training of the one or more hardware components of the UE and transmitting third signaling activating the first set of resources for the uplink response training, where receiving the second signaling may be based on the third signaling.

In some examples of the method, network entities, and non-transitory computer-readable medium described herein, the first signaling includes RRC signaling and the second signaling includes DCI or a MAC-CE.

In some examples of the method, network entities, and non-transitory computer-readable medium described herein, transmitting the first signaling may include operations, features, means, or instructions for transmitting, to a group of UEs that may be located within a cell associated with the network entity, the first signaling allocating the first set of resources for the uplink response training, where the group of UEs include the UE.

In some examples of the method, network entities, and non-transitory computer-readable medium described herein, the first set of resources includes time resources, frequency resources, or both.

In some examples of the method, network entities, and non-transitory computer-readable medium described herein, transmitting the first signaling may include operations, features, means, or instructions for transmitting a periodicity associated with the first set of resources, the periodicity including a number of slots or a number of symbols.

Some examples of the method, network entities, and non-transitory computer-readable medium described herein may further include operations, features, means, or instructions for receiving third signaling requesting resources for the uplink response training based on a trigger condition being satisfied, where transmitting the first signaling may be based on the third signaling.

In some examples of the method, network entities, and non-transitory computer-readable medium described herein, the trigger condition includes an operating temperature of the UE being above a threshold, a change in operating frequency, or a combination thereof.

In some examples of the method, network entities, and non-transitory computer-readable medium described herein, the one or more hardware components includes an amplifier, a duplexer, an antenna, a filter, an attenuator, a detector, a mixer, or a combination thereof.

### BRIEF DESCRIPTION OF THE DRAWINGS

FIGS. 1 and 2 show examples of a wireless communications system that supports resource allocation for uplink training of user equipment (UE) hardware components in accordance with one or more aspects of the present disclosure.

FIG. 3 shows an example of a process flow that supports resource allocation for uplink training of UE hardware components in accordance with one or more aspects of the present disclosure.

FIGS. 4 and 5 show block diagrams of devices that support resource allocation for uplink training of UE hardware components in accordance with one or more aspects of the present disclosure.

FIG. 6 shows a block diagram of a communications manager that supports resource allocation for uplink training of UE hardware components in accordance with one or more aspects of the present disclosure.

FIG. 7 shows a diagram of a system including a device that supports resource allocation for uplink training of UE hardware components in accordance with one or more aspects of the present disclosure.

FIGS. 8 and 9 show block diagrams of devices that support resource allocation for uplink training of UE hardware components in accordance with one or more aspects of the present disclosure.

FIG. 10 shows a block diagram of a communications manager that supports resource allocation for uplink training of UE hardware components in accordance with one or more aspects of the present disclosure.

FIG. 11 shows a diagram of a system including a device that supports resource allocation for uplink training of UE hardware components in accordance with one or more aspects of the present disclosure.

FIGS. 12 through 15 show flowcharts illustrating methods that support resource allocation for uplink training of UE hardware components in accordance with one or more aspects of the present disclosure.

### DETAILED DESCRIPTION

In some examples, a UE may include hardware components (e.g., an amplifier, a duplexer, a filter, and an antenna) that make up a transmit chain of the UE. In response to changes in UE operating conditions (e.g., frequency or temperature), a performance of the hardware components may vary and as such, the UE may tune transmission characteristics to account for the variations using one or more methods. As one method, the UE may be preconfigured with certain transmission characteristics across different UE operating conditions. But, preconfiguring the UE in such a way may introduce latency into a manufacturing process of the UE. As another method, the UE may implement online algorithms which may allow the UE to dynamically adjust transmitter characteristics in the field. But, the UE may use an uplink grant to run the online algorithms during which the UE is subjected to one or more limitations (e.g., power limitations) resulting in a delay in convergence of the online algorithms.

As described herein, a network entity may allocate resources to a UE for uplink response training of hardware components. The network entity may transmit, to the UE, a grant indicating resources (e.g., time resources, frequency resources, or both) for the uplink response training. The signaling may be broadcast signaling (e.g., directed to multiple UEs) or unicast signaling (e.g., directed to a single UE). Further, prior to the receiving the grant, the UE may signal its capability to perform uplink response training and based upon the capability of the UE, the network entity may transmit the grant.

Further, the UE may receive an indication to perform the uplink response training without apply one or more radio frequency requirements (e.g., power limitation). Upon receiving the grant, the UE may perform the uplink response training and determine one or more transmission characteristics that may optimize future communications based on the uplink response training. Using the methods as described herein may allow the UE to perform hardware component training in real time and during actual operating conditions resulting in a quick and accurate determination of transmission characteristics.

Aspects of the disclosure are initially described in the context of wireless communications systems. Additional aspects of the disclosure are described in the context of a process flow. Aspects of the disclosure are further illustrated by and described with reference to apparatus diagrams, system diagrams, and flowcharts that relate to resource allocation for uplink training of UE hardware components.

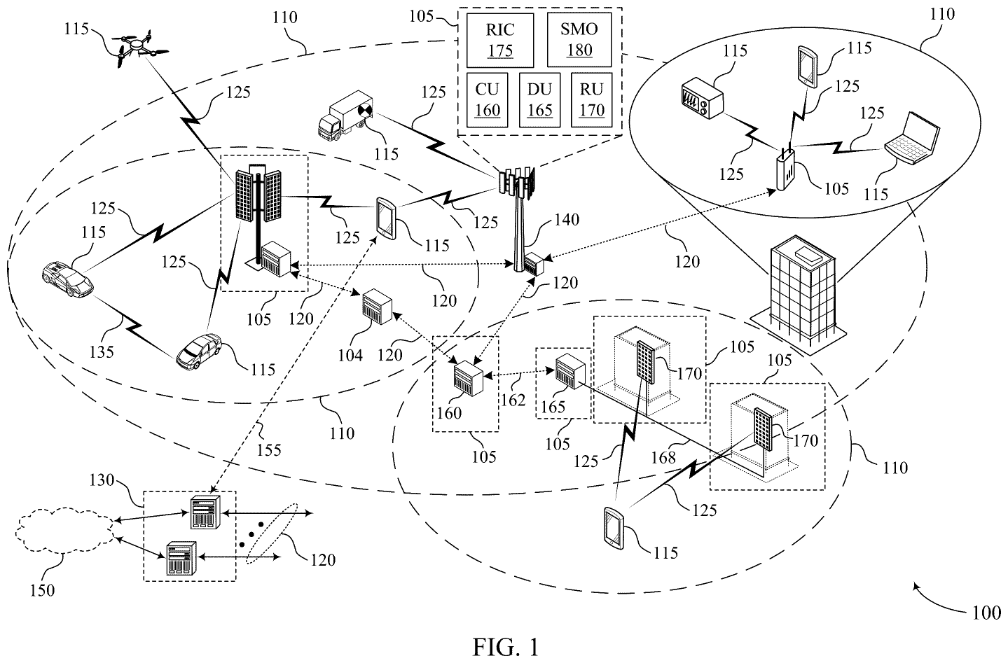

FIG. 1 shows an example of a wireless communications system 100 that supports resource allocation for uplink training of UE hardware components in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource allocation for uplink training of UE hardware components as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, a network entity 105 may allocate resources to a UE 115 for uplink response training. The UE 115 may receive, from the network entity 105, first signaling allocating a first set of resources for uplink response training of one or more hardware components that make up a radio frequency chain of the UE 115. Further, the UE 115 may perform, via the first set of resources and based on the first signaling, the uplink response training of the one or more hardware components. Additionally, the UE 115 may transmit, to the network entity and via a second set of resources, second signaling in accordance with one or more transmission characteristics that are based on the uplink response training. The methods as described herein may decrease or eliminate latencies associated with other methods. For example, the methods as described herein may decrease latency associated with manufacturing of the UE 115.

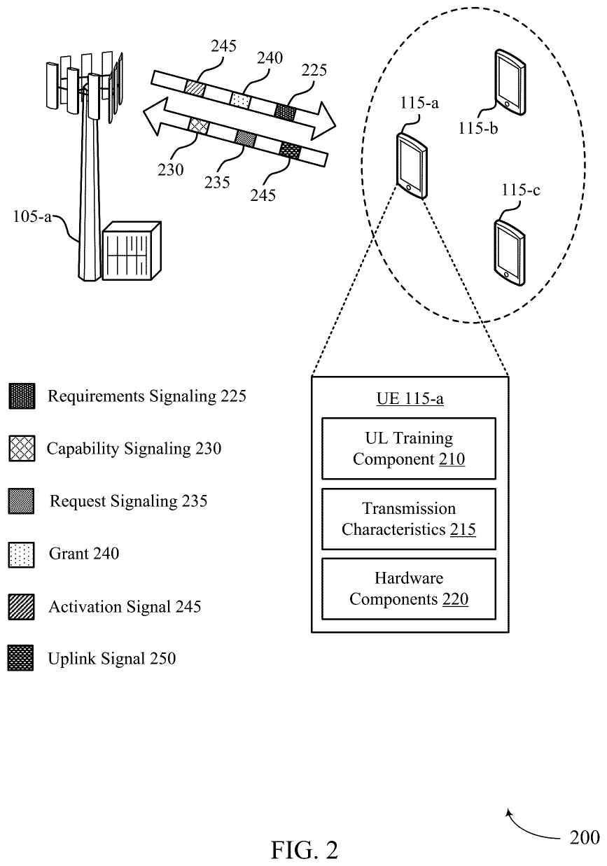

FIG. 2 shows an example of a wireless communications system 200 that supports resource allocation for uplink training of UE hardware components in accordance with one or more aspects of the present disclosure. In some examples, the wireless communications system 200 may implement aspects of a wireless communications system 100. For example, the wireless communications system 200 may include UEs 115 (e.g., a UE 115-a, a UE 115-b, and a UE 115-c) which may be examples of UEs 115 as described with reference to FIG. 1. Further, the wireless communications system 200 may include a network entity 105-a which may be an example of a network entity 105 as described with reference to FIG. 1.

In order to transmit signaling to other devices (e.g., a UE 115 or a network entity 105), a UE 115 may include a radio frequency chain. A radio frequency chain may be described as a series of hardware components that may allow the UE 115 to transform a baseband signal into a radio frequency signal. Examples of hardware components in the transmit chain may include a filter, a phase shifter, a power amplifier, a duplexer, an attenuator, a detector, a mixer, etc. In some examples, as operating conditions of the UE 115 change, a performance of the hardware components may also change. For example, a power amplifier of the UE 115 may behave in a linear manner until a threshold output power (or transmit power). As such, if an output power of the UE 115 exceeds the threshold output power, the power amplifier may behave in a non-linear manner resulting in distortions in the radio frequency signal. The performance of hardware components may also change in response to a change in an operating frequency of the UE 115 (e.g., a change in resource blocks used for transmission of the radio frequency signal) or a change in an operating temperature of the UE 115.

To counteract the potential negative performance of the hardware components of the radio frequency chain during certain operating conditions, the UE 115 may adjust one or more transmission characteristics of the UE 115. As one option, the UE 115 may be pre-configured with different transmission characteristics across different operating conditions (e.g., across different operating frequencies or different operating temperatures). For example, during manufacturing, the UE may be characterized across the different operating conditions in an offline mode in a factory using a callbox and the results (e.g., the transmission characteristics for different operating conditions) may be stored in a memory (e.g., a non-volatile memory) of the UE 115. When the UE 115 is scheduled to transmit signaling to another device, the UE 115 may read, from the memory, transmission characteristics corresponding to the current operating conditions of the UE 115 and transmit signaling to the other devices in accordance to the transmission characteristics.

As one example, the UE 115 may be scheduled to transmit signaling using an output power that is above the threshold output power and read, from the memory, transmission characteristics corresponding to the output power. In such scenario, the transmission characteristics may indicate to perform a digital pre-distortion operation in order to reduce the negative impact of a power amplifier operating in a non-linear fashion (e.g., signal distortion). Other examples of transmission characteristics may include transmission characteristics that indicate to limit the output power of the UE 115 such as to decrease the operating temperature of the UE 115 and increase a digital gain of the power amplifier.

However, there are some drawbacks to this option. For example, characterizing the UE 115 in such a way may increase the time that the UE 115 is at the factory which may introduce latency in the overall manufacturing of the UE 115. Further, as technology advances, the number of operating conditions that UE 115 may be subject to may change or increase (e.g., an operating frequency of the UE 115 may increase). If new operating conditions are added after the UE 115 leaves the factory, there is no way to characterize the UE 115 across the new operating conditions and without such characterization, the UE 115 may not counteract the negative performance of the hardware components caused by the new operating conditions.

As another option, the UE 115 may utilize online algorithms to counteract the variations in performance of hardware components during different operating conditions of the UE 115. For example, the UE 115 may be scheduled to transmit a signal to another device (e.g., another UE 115 or a network entity 105). During transmission, the UE 115 may utilize a feedback receiver to capture the transmitted signal at an antenna of the UE 115 and compare the transmitted signal to the baseband signal (e.g., overlay the transmitted signal with the baseband signal). Further, the UE 115 may determine, based on the comparison, whether there are any non-linear impairments that have been introduced into the transmitted signal due to the hardware components of the UE 115.

If non-linear impairments are found, the UE 115 may run online algorithms to discover a way to increase or improve a signal quality of a subsequent signal transmission using the current operating conditions (e.g., operating conditions used to transmit the signal). As one example, the online algorithms may adjust different combinations of transmission characteristics until the signal quality is improved (or the algorithms converge). In order to run the online algorithms, the UE 115 is allocated an uplink grant (e.g., from a network entity 105). However, in some examples, the UE 115 must apply one or more frequency requirements (e.g., uplink power control) to resources allocated in the uplink grant which may delay convergence of the algorithms. Further, operating conditions at the UE 115 may change quickly. If the operating conditions of the UE 115 change, after transmission of the signal and prior to convergence of the online algorithms, the transmission characteristics may no longer apply to subsequent signal transmissions performed by the UE 115.

As described herein, a network entity 105 may allocate resources to a UE 115 for uplink response training of one or more hardware components of the UE 115. In some examples, the network entity 105-a may transmit requirements signaling 225 to the UE 115-a. The requirements signaling 225 may indicate one or more radio frequency requirements that may limit one or more actions of the UE 115-a during one or more uplink slots. For example, the radio frequency requirements may indicate a threshold uplink power (e.g., uplink power control) that the UE 115-a cannot exceed while communicating in one or more uplink slots. Other examples of radio frequency requirements that may be included in the requirements signaling 225 may be a threshold signal quality or a threshold amount of in-band emission that the UE 115-a must meet or exceed while communicating during the one or more uplink slots or a threshold amount of out-of-band emission that the UE 115-a must not exceed while communicating during the one or more uplink slots.

In some examples, uplink response training may be supported by some UEs 115 (e.g., premium tier devices) and not supported by other UEs 115. Considering this, UEs 115 may transmit capability signaling 230 indicating whether the UEs 115 support uplink response training. For example, using an uplink training component 210, the UE 115-a may transmit capability signaling 230 to the network entity 105-a indicating its ability to perform uplink response training (or Enhanced-UL-Training-r20). In addition to the UE 115-a, other UEs 115 in the same cell (e.g., the UE 115-b and the UE 115-c) may also transmit capability signaling 230 to the network entity 105-a. For example, the UE 115-b may transmit capability signaling 230 to the network entity 105-a indicating its ability to perform uplink response training and the UE 115-c may transmit capability signaling 230 to the network entity 105-a indicating its inability to perform uplink response training.

Additionally, in some examples, UEs 115 capable of performing uplink response training may request resources for performing the uplink response training. For example, using the uplink training component 210, the UE 115-a may transmit request signaling 235 to the network entity 105-a requesting a resource allocation for uplink response training. In some examples, UEs 115 may transmit the request signaling 235 upon satisfaction of one or more trigger conditions. As an example, the UE 115-a may monitor its operating temperate and transmit the request signaling 235 when the operating temperate meets or exceeds a threshold. Other examples of trigger conditions may include any other changes in operating conditions of the UE 115 (e.g., a change in operating frequency). In some examples, the UE 115 may monitor for a change in operating conditions in response to completing first uplink response training and if a change is detected, the UE 115 may transmit the request signaling 235 requesting a resource allocation for second uplink response training.

The request signaling 235 may be included in UE assistance information (UAI), a MAC-control element (MAC-CE), or any other uplink signaling to the network entity 105-a. Further, if the UEs 115 no longer require resources for uplink response training, the UEs 115 may send a similar signal (e.g., similar to the requesting signaling 235) requesting that the network entity 105-a refrain from scheduling the UEs 115 to perform uplink response training.

In some examples, the network entity 105-a may transmit a grant 240 for uplink response training to one or more of the UEs 115 (e.g., in response to the request signaling 235). The network entity 105-a may transmit the grant 240 using unicast signaling (e.g., to a single UE 115) or broadcast signaling (e.g., to multiple UEs 115). Further, in some examples, the network entity 105-a may only transmit the grant 240 to the UEs 115 whose capability signaling 230 indicates support for uplink response training (e.g., the UE 115-a and the UE 115-b). The UEs 115 whose capability signaling 230 does not indicate support for uplink response training (e.g., the UE 115-c) may not be scheduled by the network entity 105-a to perform uplink response training via the grant 240.

In one example, the grant 240 may indicate dedicated resources in time and frequency that the one or more UEs 115 may utilize to perform uplink response training. As another example, the grant 240 may indicate periodically reoccurring slots or symbols as well as a specific resource block location in the slot or symbols that the one or more UEs 115 may utilize to perform the uplink response training. In such example, the grant 240 may be included in RRC signaling. Alternatively, the grant 240 may indicate a slot or a symbol (e.g., time resources) and the one or more UEs 115 may select frequency resources within the slot or symbol (e.g., resource of interest) to utilize for uplink response training.

Alternatively or additionally, the grant 240 may include multiple options for uplink response training resources. For example, the grant 240 may include a first set of time and frequency resources and a second set of time and frequency resources different from the first set of time and frequency resources. In such example, the grant 240 may be included in RRC signaling and the network entity 105-a may activate the grant 240 by transmitting activation signaling 245 (e.g., a MAC-CE or downlink control information (DCI)) to the one or more UEs 115 on a need basis.

As another example, the grant 240 may be included in existing signaling between the network entity 105-a and the one or more UEs 115. For example, the grant 240 may be included in a DCI scheduling uplink communication. In such example, the DCI may include an indication that the grant 240 is for uplink response training. The indication may be a bit field in the DCI that includes one or more bits (e.g., a flag) and a logic value of the one or more bits may indicate that the grant 240 in the DCI is to be used for uplink response training. This option may allow the one or more UEs 115 to utilize existing signaling for uplink response training without having to dedicate additional resources which may improve the network's spectral efficiency.

Additionally, included in the grant 240 or other signaling, may be an indication to perform the uplink response training using relaxed radio frequency requirements. Performing the uplink response training using relaxed radio frequency requirement may include performing the uplink response training without applying one or more of the radio frequency requirements indicated in the requirements signaling 225 or pre-configured at the UEs 115. As an example, in response to receiving such indication, the UE 115-a may perform the uplink response training without adhering to uplink power control. That is, during uplink response training, the UE 115-a may transmit signaling using an output power that is greater than the output power threshold. This may allow the UE 115 to perform uplink response training without degraded performance and with decreased latency.

However, in some examples, performing uplink response training without restraint or using relaxed requirements may cause uplink signaling transmitted from UEs 115 during the uplink response training to leak into out-of-band resources potentially causing interference at other UEs 115. In such case, the network entity 105-a may refrain from scheduling other UEs 115 (e.g., UEs 115 not performing uplink response training or UEs 115 not capable of performing uplink response training) during the uplink slots allocated for uplink response training or the network entity 105-a may schedule the other UEs 115 during the uplink slots used for uplink response training, but at a low MCS for best effort decoding.

Upon receiving the grant 240, the one or more UEs 115 may perform the uplink response training via the resource allocation indicated in the grant 240. The uplink response training may allow a UE 115 to analyze it's the hardware components 220 during varying operating conditions and determine what transmission characteristics 215 to use during these varying operating conditions to increase signal quality. As one example, using the uplink training component 210, the UE 115-a may transmit uplink signaling according to varying output powers and analyze the behavior of the power amplifier. If the power amplifier operates in a non-linear fashion at a certain output power, the UE 115-a may determine to perform digital pre-distortion when the UE 115-a encounters the certain output power for subsequent uplink transmissions.

As another example of uplink response training, the UE 115-a may monitor a capability of the power amplifier (e.g., power amplifier gain) as a function of operating temperature. If there is a significant drop in power amplifier gain, the UE 115-a may identify the operating temperature and limit the output power on subsequent uplink transmissions such as to keep the operating temperate below the identified operating temperature. Further, the one or more UEs 115 may store the transmissions characteristics 215 determined from the uplink response training in their memory.

After completing the uplink response training, the one or more UEs 115 may communicate with the network entity 105-a using the transmission characteristics 215 determined from the uplink response training. For example, the UE 115-a may receive an uplink grant from the network entity 105-a scheduling the UE 115-a to transmit an uplink signal 250 to the network entity 105-a. Upon receiving the uplink grant, the UE 115-a may transmit the uplink signal 250 to the network entity 105-a in accordance with the one or more determined transmission characteristics 215. Using the methods as described herein may allow a UE to perform real-time training of hardware components 220 under actual operating conditions which may increase accuracy. Further, given that the methods are performed in conjunction with the network entity 105-a, the UE 115 may perform training with relaxed requirements which may allow the UE 115 to perform more extensive uplink response training

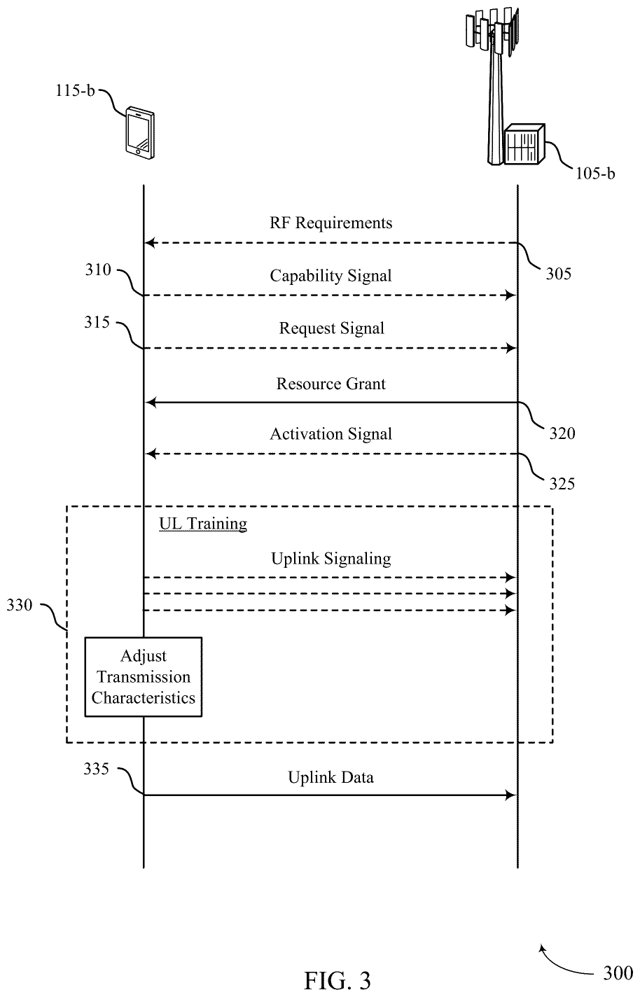

FIG. 3 shows an example of a process flow 300 that supports resource allocation for uplink training of UE hardware components in accordance with one or more aspects of the present disclosure. In some examples, the process flow 300 may implement, or be implemented by, aspects of a wireless communications system 100 and a wireless communications system 200. For example, the process flow 300 may be implemented by a network entity 105-b and a UE 115-b which may be examples of a UE 115 and a network entity 105 as described with reference to FIGS. 1 and 2, respectively. Alternative examples of the following may be implemented, where some steps are performed in a different order then described or are not performed at all. In some cases, steps may include additional features not mentioned below, or further steps may be added.

At 305, the UE 115-b may optionally receive, from the network entity 105-b, signaling indicating one or more radio frequency requirement for the UE 115-b. The one or more radio frequency requirements may include a threshold uplink power, a threshold signal quality, a threshold amount of out-of-band emission, a threshold amount of in-band emission, or a combination thereof.

At 310, the UE 115-b may optionally transmit, to the network entity 105-b, signaling indicating a capability of the UE 115-b to perform uplink response training of one or more hardware components that make up a transmit chain of the UE 115-b. Examples of hardware components may include an amplifier, a duplexer, an antenna, a filter, an attenuator, a detector, a mixer, or a combination thereof.

At 315, the UE 115-b may optionally transmit, to the network entity 105-b, signaling requesting resources for the uplink response training. In some examples, the UE 115-b may transmit the request based on satisfaction of a trigger condition. The trigger condition may include an operating temperature of the UE 115-b exceeding a threshold, a change in operating frequency of the UE 115-b, or a combination thereof.

At 320, the UE 115-b may receive, from the network entity 105-b, signaling allocating a first set of resources for the uplink response training. In some examples, the UE 115-b may receive the resource grant in response to the capability signaling or the request signaling. Further, the first set of resources may include time resources, frequency resources, or both. Additionally, the signaling allocating the first set of resources may include one or more bits and logic values of the one or more bits may indicate that the first set of resources are for uplink response training.

Additionally or alternatively, the signaling may also include a periodicity associated with the first set of resources. In some examples, the periodicity may include a number of slots or a number of symbols. In addition to the first set of resources, the signaling may include a second set of resources. In such example, the UE 115-b may additionally receive signaling (e.g., DCI or a MAC-CE) activating the first set of resource for uplink response training at 325.

At 330, the UE 115-b may perform, via the first set of resources, the uplink response training. In some examples, the UE 115-b may perform the uplink response training in response to the resource grant. Performing the uplink response training may include monitoring, while transmitting uplink signaling, a performance metric of a power amplifier of the UE 115-b and adjusting transmission characteristics of the UE 115-b based on the performance metric. Adjusting the transmission characteristics may include performing a digital pre-distortion on subsequent uplink data transmissions based on the performance metric indicating that the power amplifier is operating in a non-linear manner.

At 335, the UE 115-b may transmit, to the network entity 105-b and via a third set of resources, uplink data in accordance with the one or more transmission characteristics determined during the uplink response training.

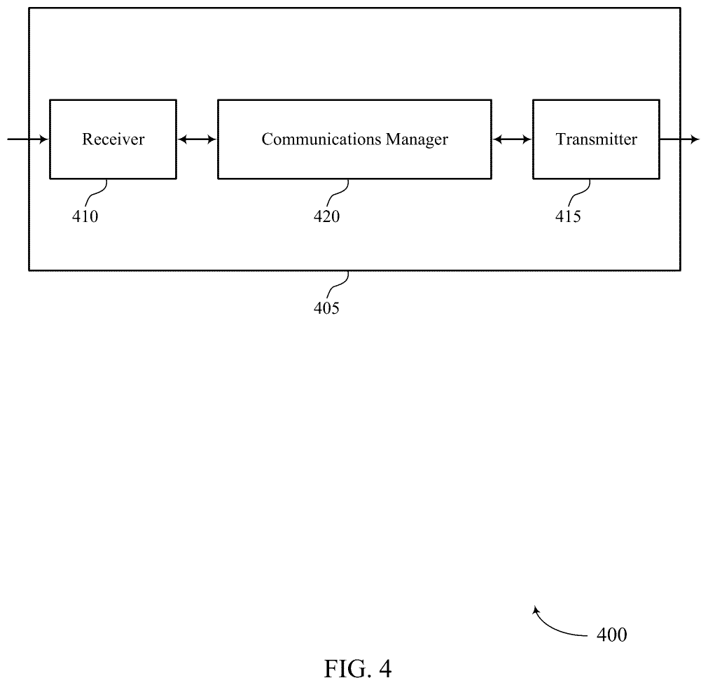

FIG. 4 shows a block diagram 400 of a device 405 that supports resource allocation for uplink training of UE hardware components in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to resource allocation for uplink training of UE hardware components). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to resource allocation for uplink training of UE hardware components). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of resource allocation for uplink training of UE hardware components as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a network entity, first signaling allocating a first set of resources for uplink response training of one or more hardware components of the UE, the one or more hardware components including a radio frequency chain of the UE. The communications manager 420 is capable of, configured to, or operable to support a means for performing, via the first set of resources and based on the first signaling, the uplink response training of the one or more hardware components of the UE. The communications manager 420 is capable of, configured to, or operable to support a means for transmitting, to the network entity and via a second set of resources, second signaling in accordance with one or more transmission characteristics, the one or more transmission characteristics based on the uplink response training.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing and more efficient utilization of communication resources.

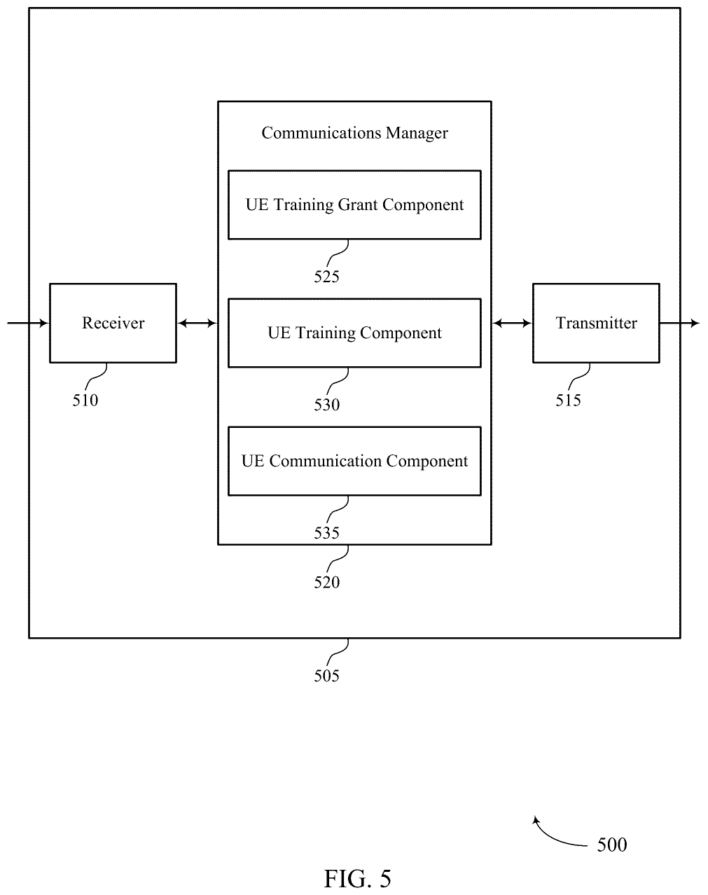

FIG. 5 shows a block diagram 500 of a device 505 that supports resource allocation for uplink training of UE hardware components in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to resource allocation for uplink training of UE hardware components). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to resource allocation for uplink training of UE hardware components). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of resource allocation for uplink training of UE hardware components as described herein. For example, the communications manager 520 may include a UE training grant component 525, a UE training component 530, a UE communication component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The UE training grant component 525 is capable of, configured to, or operable to support a means for receiving, from a network entity, first signaling allocating a first set of resources for uplink response training of one or more hardware components of the UE, the one or more hardware components including a radio frequency chain of the UE. The UE training component 530 is capable of, configured to, or operable to support a means for performing, via the first set of resources and based on the first signaling, the uplink response training of the one or more hardware components of the UE. The UE communication component 535 is capable of, configured to, or operable to support a means for transmitting, to the network entity and via a second set of resources, second signaling in accordance with one or more transmission characteristics, the one or more transmission characteristics based on the uplink response training.

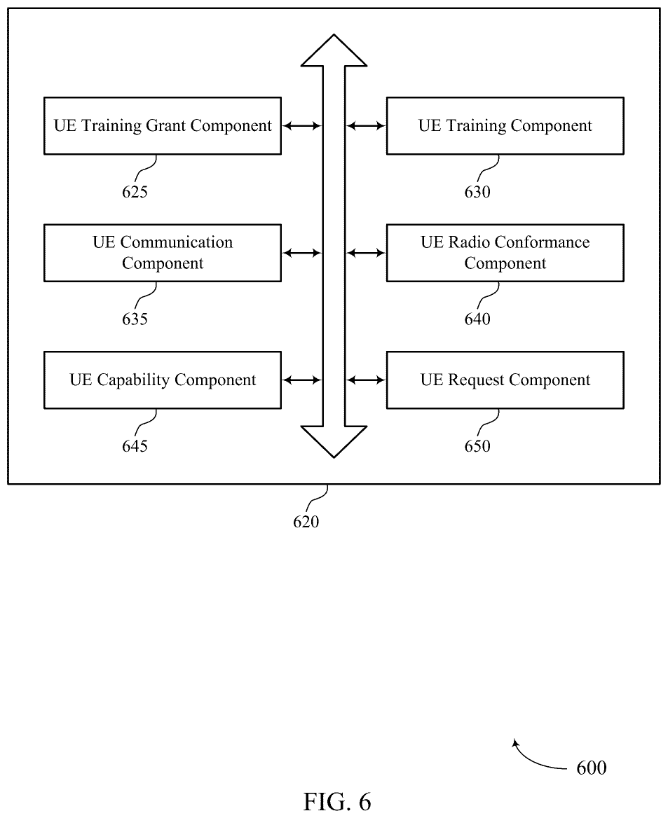

FIG. 6 shows a block diagram 600 of a communications manager 620 that supports resource allocation for uplink training of UE hardware components in accordance with one or more aspects of the present disclosure. The communications manager 620 may be an example of aspects of a communications manager 420, a communications manager 520, or both, as described herein. The communications manager 620, or various components thereof, may be an example of means for performing various aspects of resource allocation for uplink training of UE hardware components as described herein. For example, the communications manager 620 may include a UE training grant component 625, a UE training component 630, a UE communication component 635, a UE radio conformance component 640, a UE capability component 645, a UE request component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The UE training grant component 625 is capable of, configured to, or operable to support a means for receiving, from a network entity, first signaling allocating a first set of resources for uplink response training of one or more hardware components of the UE, the one or more hardware components including a radio frequency chain of the UE. The UE training component 630 is capable of, configured to, or operable to support a means for performing, via the first set of resources and based on the first signaling, the uplink response training of the one or more hardware components of the UE. The UE communication component 635 is capable of, configured to, or operable to support a means for transmitting, to the network entity and via a second set of resources, second signaling in accordance with one or more transmission characteristics, the one or more transmission characteristics based on the uplink response training.

In some examples, the UE radio conformance component 640 is capable of, configured to, or operable to support a means for receiving, from the network entity, third signaling indicating one or more radio frequency requirements for the UE, where the UE performs the uplink response training without applying at least one radio frequency requirement of the one or more radio frequency requirements.

In some examples, the one or more radio frequency requirements include a threshold uplink power, a threshold signal quality value, a threshold amount of out-of-band emission, a threshold amount of in-band emission, or a combination thereof.

In some examples, the first signaling includes one or more bits. In some examples, logic values of the one or more bits indicate that the first set of resources are for the uplink response training.

In some examples, the UE capability component 645 is capable of, configured to, or operable to support a means for transmitting third signaling indicating a capability of the UE to perform the uplink response training, where receiving the first signaling is based on the capability of the UE to perform the uplink response training.

In some examples, to support receiving the first signaling, the UE training grant component 625 is capable of, configured to, or operable to support a means for receiving the first signaling allocating the first set of resources and a third set of resources for the uplink response training of the one or more hardware components of the UE. In some examples, to support receiving the first signaling, the UE training grant component 625 is capable of, configured to, or operable to support a means for receiving third signaling activating the first set of resources for the uplink response training, where performing the uplink response training via the first set of resources is based on the third signaling.

In some examples, the first signaling includes RRC signaling and the second signaling includes DCI or a MAC-CE. In some examples, the first set of resources includes time resources, frequency resources, or both.

In some examples, to support receiving the first signaling, the UE training grant component 625 is capable of, configured to, or operable to support a means for receiving a periodicity associated with the first set of resources, the periodicity including a number of slots or a number of symbols, where performing the uplink response training via the first set of resources is based on the periodicity.

In some examples, the UE request component 650 is capable of, configured to, or operable to support a means for transmitting third signaling requesting resources for the uplink response training based on a trigger condition being satisfied, where receiving the first signaling is based on the third signaling. In some examples, the trigger condition includes an operating temperature of the UE being above a threshold, a change in operating frequency, or a combination thereof.

In some examples, to support performing the uplink response training, the UE training component 630 is capable of, configured to, or operable to support a means for monitoring, while transmitting uplink signaling, a performance metric of a power amplifier of the UE, where transmitting the second signaling according to the one or more transmission characteristics includes. In some examples, to support performing the uplink response training, the UE training component 630 is capable of, configured to, or operable to support a means for performing a digital pre-distortion operation on the second signaling based on the performance metric indicating that the power amplifier is operating in a non-linear manner. In some examples, the one or more hardware components includes an amplifier, a duplexer, an antenna, a filter, an attenuator, a detector, a mixer, or a combination thereof.

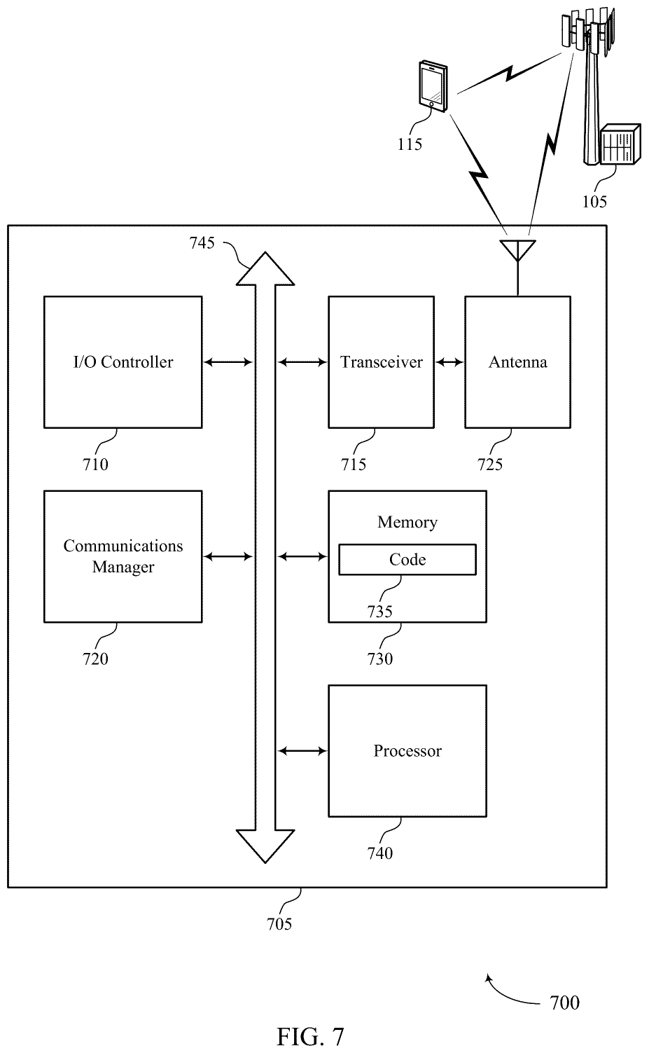

FIG. 7 shows a diagram of a system 700 including a device 705 that supports resource allocation for uplink training of UE hardware components in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting resource allocation for uplink training of UE hardware components). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a network entity, first signaling allocating a first set of resources for uplink response training of one or more hardware components of the UE, the one or more hardware components including a radio frequency chain of the UE. The communications manager 720 is capable of, configured to, or operable to support a means for performing, via the first set of resources and based on the first signaling, the uplink response training of the one or more hardware components of the UE. The communications manager 720 is capable of, configured to, or operable to support a means for transmitting, to the network entity and via a second set of resources, second signaling in accordance with one or more transmission characteristics, the one or more transmission characteristics based on the uplink response training.

By including or configuring the communications manager 720 in accordance with examples as described herein, the device 705 may support techniques for improved communication reliability, reduced latency, and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of resource allocation for uplink training of UE hardware components as described herein, or the at least one processor 740 and the at least one memory 730 may be otherwise configured to, individually or collectively, perform or support such operations.

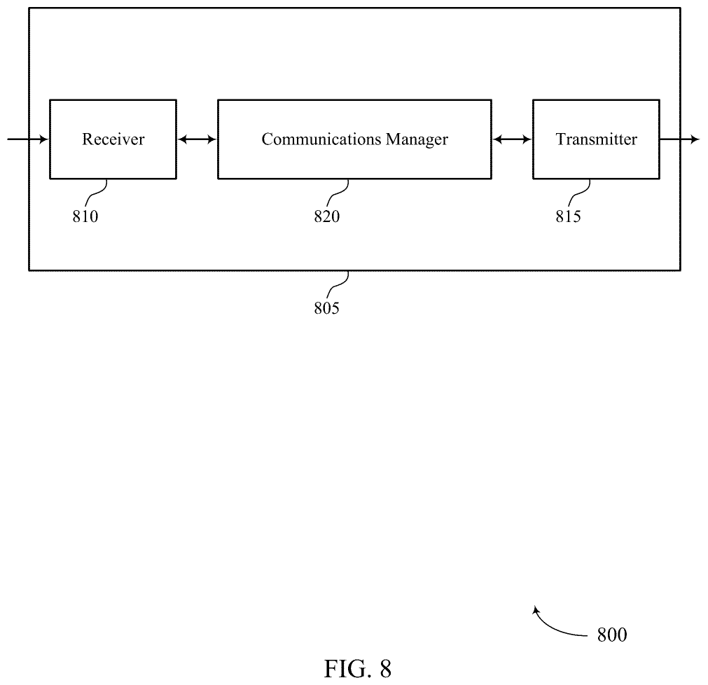

FIG. 8 shows a block diagram 800 of a device 805 that supports resource allocation for uplink training of UE hardware components in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of resource allocation for uplink training of UE hardware components as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting, to a UE, first signaling allocating a first set of resources for uplink response training of one or more hardware components of the UE, the one or more hardware components including a radio frequency chain of the UE. The communications manager 820 is capable of, configured to, or operable to support a means for receiving, from the UE and via a second set of resources, second signaling in accordance with one or more transmission characteristics, the one or more transmission characteristics based on the uplink response training.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing and more efficient utilization of communication resources.

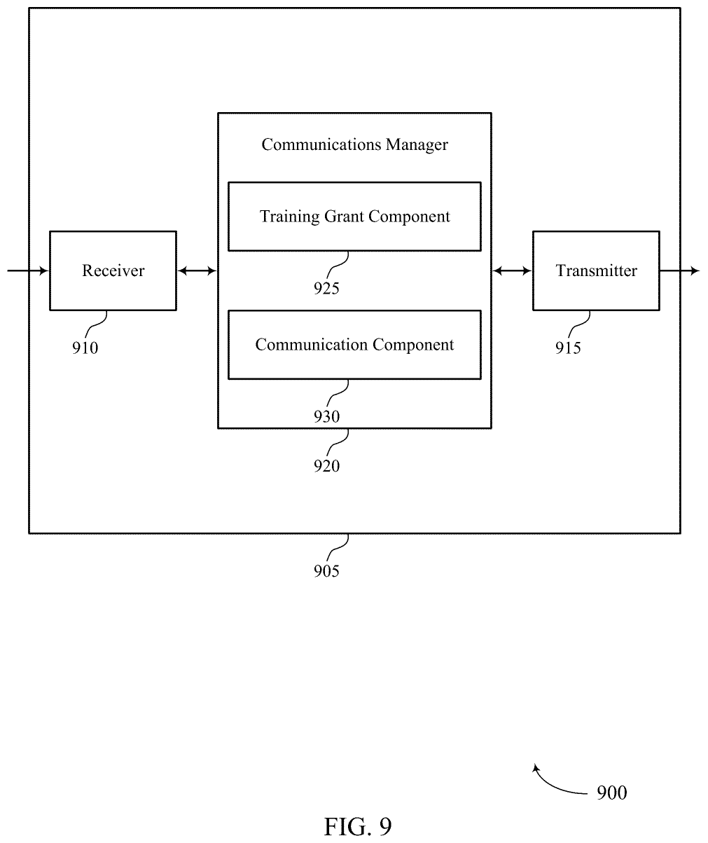

FIG. 9 shows a block diagram 900 of a device 905 that supports resource allocation for uplink training of UE hardware components in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of resource allocation for uplink training of UE hardware components as described herein. For example, the communications manager 920 may include a training grant component 925 a communication component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The training grant component 925 is capable of, configured to, or operable to support a means for transmitting, to a UE, first signaling allocating a first set of resources for uplink response training of one or more hardware components of the UE, the one or more hardware components including a radio frequency chain of the UE. The communication component 930 is capable of, configured to, or operable to support a means for receiving, from the UE and via a second set of resources, second signaling in accordance with one or more transmission characteristics, the one or more transmission characteristics based on the uplink response training.

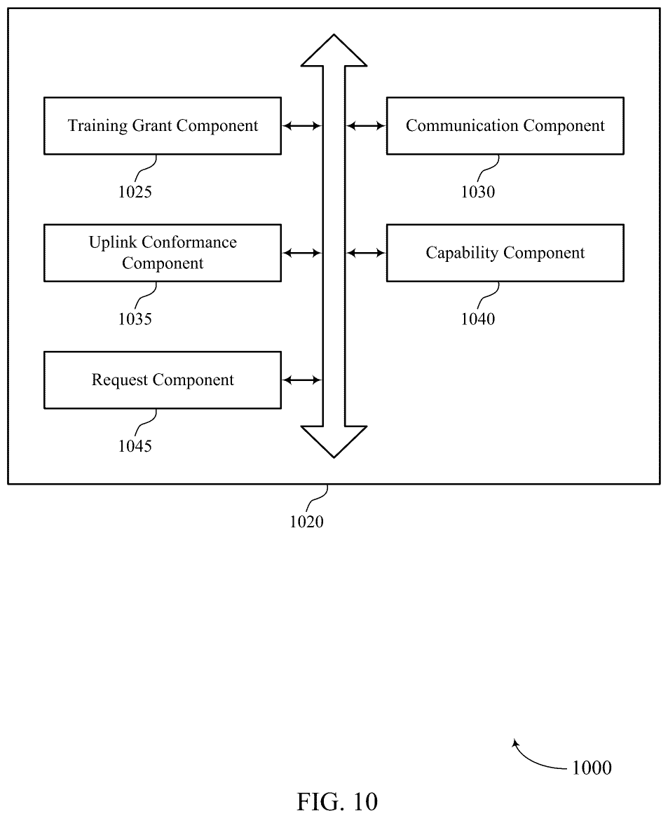

FIG. 10 shows a block diagram 1000 of a communications manager 1020 that supports resource allocation for uplink training of UE hardware components in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of resource allocation for uplink training of UE hardware components as described herein. For example, the communications manager 1020 may include a training grant component 1025, a communication component 1030, an uplink conformance component 1035, a capability component 1040, a request component 1045, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The training grant component 1025 is capable of, configured to, or operable to support a means for transmitting, to a UE, first signaling allocating a first set of resources for uplink response training of one or more hardware components of the UE, the one or more hardware components including a radio frequency chain of the UE. The communication component 1030 is capable of, configured to, or operable to support a means for receiving, from the UE and via a second set of resources, second signaling in accordance with one or more transmission characteristics, the one or more transmission characteristics based on the uplink response training.

In some examples, the uplink conformance component 1035 is capable of, configured to, or operable to support a means for transmitting, to the UE, third signaling indicating one or more radio frequency requirements for the UE. In some examples, the one or more radio frequency requirements include a threshold uplink power, a threshold signal quality value, a threshold amount of out-of-band emission, a threshold amount of in-band emission, or a combination thereof. In some examples, the first signaling includes one or more bits. In some examples, logic values of the one or more bits indicate that the first set of resources are for the uplink response training.

In some examples, the capability component 1040 is capable of, configured to, or operable to support a means for receiving third signaling indicating a capability of the UE to perform the uplink response training, where transmitting the first signaling is based on the capability of the UE to perform the uplink response training.

In some examples, to support transmitting the first signaling, the training grant component 1025 is capable of, configured to, or operable to support a means for transmitting the first signaling allocating the first set of resources and a third set of resources for the uplink response training of the one or more hardware components of the UE. In some examples, to support transmitting the first signaling, the training grant component 1025 is capable of, configured to, or operable to support a means for transmitting third signaling activating the first set of resources for the uplink response training, where receiving the second signaling is based on the third signaling. In some examples, the first signaling includes RRC signaling and the second signaling includes DCI or a MAC-CE.

In some examples, to support transmitting the first signaling, the training grant component 1025 is capable of, configured to, or operable to support a means for transmitting, to a group of UEs that are located within a cell associated with the network entity, the first signaling allocating the first set of resources for the uplink response training, where the group of UEs include the UE. In some examples, the first set of resources includes time resources, frequency resources, or both.

In some examples, to support transmitting the first signaling, the training grant component 1025 is capable of, configured to, or operable to support a means for transmitting a periodicity associated with the first set of resources, the periodicity including a number of slots or a number of symbols.

In some examples, the request component 1045 is capable of, configured to, or operable to support a means for receiving third signaling requesting resources for the uplink response training based on a trigger condition being satisfied, where transmitting the first signaling is based on the third signaling.

In some examples, the trigger condition includes an operating temperature of the UE being above a threshold, a change in operating frequency, or a combination thereof. In some examples, the one or more hardware components includes an amplifier, a duplexer, an antenna, a filter, an attenuator, a detector, a mixer, or a combination thereof.

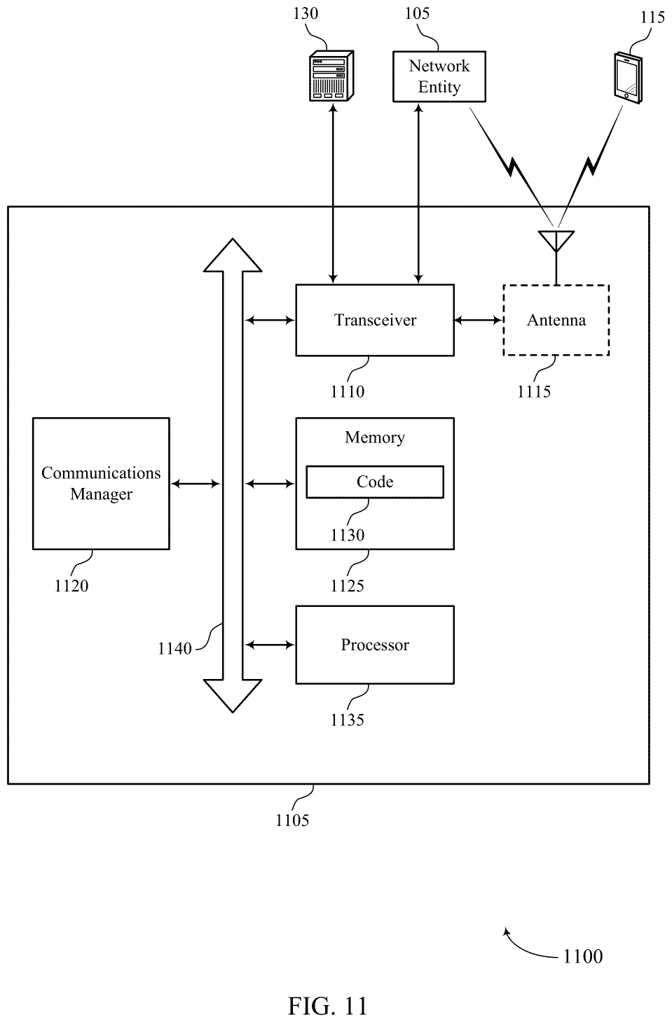

FIG. 11 shows a diagram of a system 1100 including a device 1105 that supports resource allocation for uplink training of UE hardware components in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting resource allocation for uplink training of UE hardware components). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting, to a UE, first signaling allocating a first set of resources for uplink response training of one or more hardware components of the UE, the one or more hardware components including a radio frequency chain of the UE. The communications manager 1120 is capable of, configured to, or operable to support a means for receiving, from the UE and via a second set of resources, second signaling in accordance with one or more transmission characteristics, the one or more transmission characteristics based on the uplink response training.

By including or configuring the communications manager 1120 in accordance with examples as described herein, the device 1105 may support techniques for improved communication reliability, reduced latency, and more efficient utilization of communication resources. In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of resource allocation for uplink training of UE hardware components as described herein, or the at least one processor 1135 and the at least one memory 1125 may be otherwise configured to, individually or collectively, perform or support such operations.

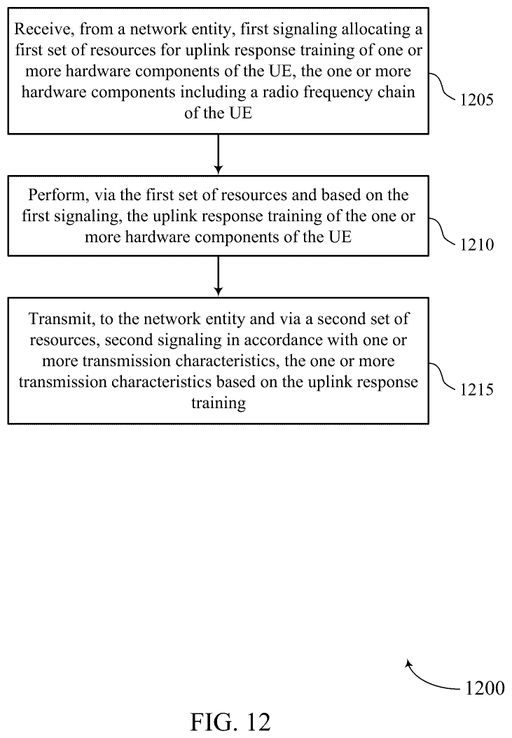

FIG. 12 shows a flowchart illustrating a method 1200 that supports resource allocation for uplink training of UE hardware components in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, first signaling allocating a first set of resources for uplink response training of one or more hardware components of the UE, the one or more hardware components including a radio frequency chain of the UE. The operations of block 1205 may be performed in accordance with examples as disclosed herein. In some examples, aspects of the operations of 1205 may be performed by a UE training grant component 625 as described with reference to FIG. 6.

At 1210, the method may include performing, via the first set of resources and based on the first signaling, the uplink response training of the one or more hardware components of the UE. The operations of block 1210 may be performed in accordance with examples as disclosed herein. In some examples, aspects of the operations of 1210 may be performed by a UE training component 630 as described with reference to FIG. 6.

At 1215, the method may include transmitting, to the network entity and via a second set of resources, second signaling in accordance with one or more transmission characteristics, the one or more transmission characteristics based on the uplink response training. The operations of block 1215 may be performed in accordance with examples as disclosed herein. In some examples, aspects of the operations of 1215 may be performed by a UE communication component 635 as described with reference to FIG. 6.

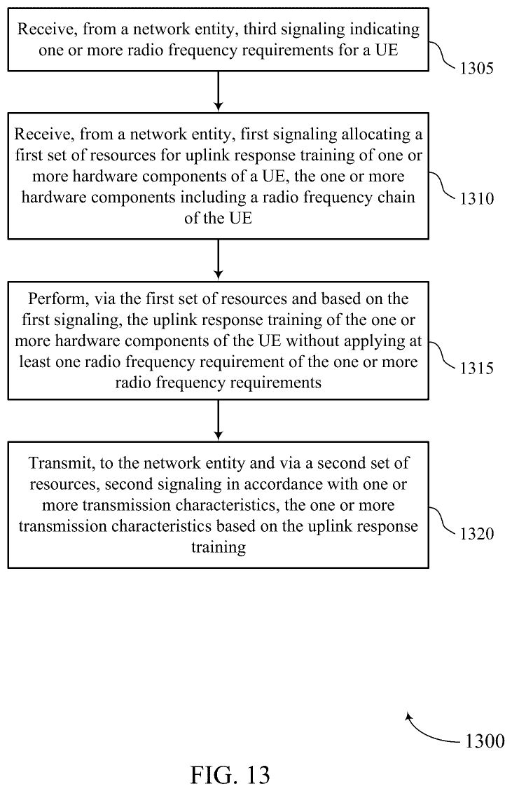

FIG. 13 shows a flowchart illustrating a method 1300 that supports resource allocation for uplink training of UE hardware components in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, third signaling indicating one or more radio frequency requirements for a UE. The operations of block 1305 may be performed in accordance with examples as disclosed herein. In some examples, aspects of the operations of 1305 may be performed by a UE radio conformance component 640 as described with reference to FIG. 6.

At 1310, the method may include receiving, from the network entity, first signaling allocating a first set of resources for uplink response training of one or more hardware components of the UE, the one or more hardware components including a radio frequency chain of the UE. The operations of block 1310 may be performed in accordance with examples as disclosed herein. In some examples, aspects of the operations of 1310 may be performed by a UE training grant component 625 as described with reference to FIG. 6.

At 1315, the method may include performing, via the first set of resources and based on the first signaling, the uplink response training of the one or more hardware components of the UE without applying at least one radio frequency requirement of the one or more radio frequency requirements. The operations of block 1315 may be performed in accordance with examples as disclosed herein. In some examples, aspects of the operations of 1315 may be performed by a UE training component 630 as described with reference to FIG. 6.

At 1320, the method may include transmitting, to the network entity and via a second set of resources, second signaling in accordance with one or more transmission characteristics, the one or more transmission characteristics based on the uplink response training. The operations of block 1320 may be performed in accordance with examples as disclosed herein. In some examples, aspects of the operations of 1320 may be performed by a UE communication component 635 as described with reference to FIG. 6.

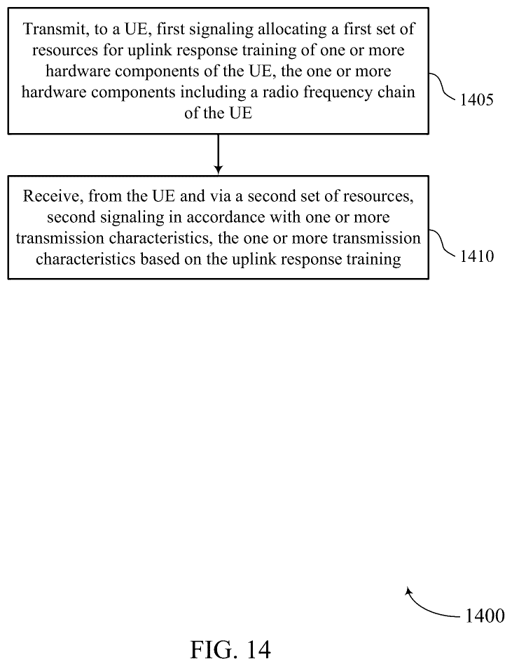

FIG. 14 shows a flowchart illustrating a method 1400 that supports resource allocation for uplink training of UE hardware components in accordance with aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, first signaling allocating a first set of resources for uplink response training of one or more hardware components of the UE, the one or more hardware components including a radio frequency chain of the UE. The operations of block 1405 may be performed in accordance with examples as disclosed herein. In some examples, aspects of the operations of 1405 may be performed by a training grant component 1025 as described with reference to FIG. 10.

At 1410, the method may include receiving, from the UE and via a second set of resources, second signaling in accordance with one or more transmission characteristics, the one or more transmission characteristics based on the uplink response training. The operations of block 1410 may be performed in accordance with examples as disclosed herein. In some examples, aspects of the operations of 1410 may be performed by a communication component 1030 as described with reference to FIG. 10.

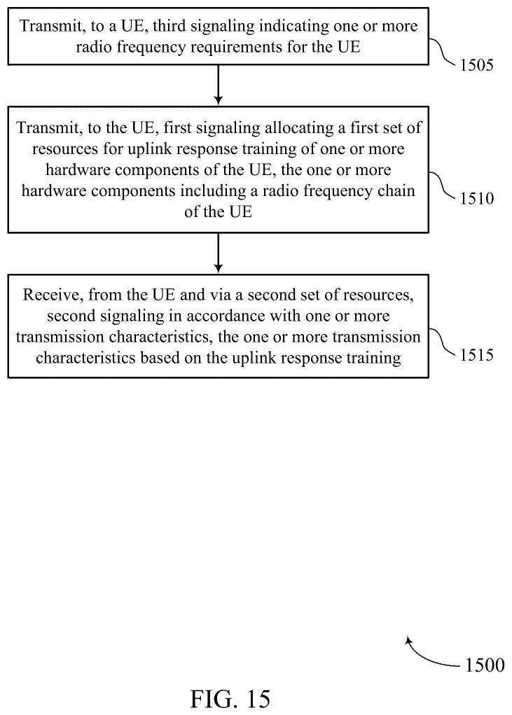

FIG. 15 shows a flowchart illustrating a method 1500 that supports resource allocation for uplink training of UE hardware components in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, third signaling indicating one or more radio frequency requirements for the UE. The operations of block 1505 may be performed in accordance with examples as disclosed herein. In some examples, aspects of the operations of 1505 may be performed by an uplink conformance component 1035 as described with reference to FIG. 10.

At 1510, the method may include transmitting, to the UE, first signaling allocating a first set of resources for uplink response training of one or more hardware components of the UE, the one or more hardware components including a radio frequency chain of the UE. The operations of block 1510 may be performed in accordance with examples as disclosed herein. In some examples, aspects of the operations of 1510 may be performed by a training grant component 1025 as described with reference to FIG. 10.

At 1515, the method may include receiving, from the UE and via a second set of resources, second signaling in accordance with one or more transmission characteristics, the one or more transmission characteristics based on the uplink response training. The operations of block 1515 may be performed in accordance with examples as disclosed herein. In some examples, aspects of the operations of 1515 may be performed by a communication component 1030 as described with reference to FIG. 10.

The following provides an overview of aspects of the present disclosure:

Aspect 1: A method for wireless communications at a UE, comprising: receiving, from a network entity, first signaling allocating a first set of resources for uplink response training of one or more hardware components of the UE, the one or more hardware components comprising a radio frequency chain of the UE; performing, via the first set of resources and based at least in part on the first signaling, the uplink response training of the one or more hardware components of the UE; and transmitting, to the network entity and via a second set of resources, second signaling in accordance with one or more transmission characteristics, the one or more transmission characteristics based at least in part on the uplink response training.

Aspect 2: The method of aspect 1, further comprising: receiving, from the network entity, third signaling indicating one or more radio frequency requirements for the UE, wherein the UE performs the uplink response training without applying at least one radio frequency requirement of the one or more radio frequency requirements.

Aspect 3: The method of aspect 2, wherein the one or more radio frequency requirements comprise a threshold uplink power, a threshold signal quality value, a threshold amount of out-of-band emission, a threshold amount of in-band emission, or a combination thereof.

Aspect 4: The method of any of aspects 1 through 3, wherein the first signaling comprises one or more bits, and logic values of the one or more bits indicate that the first set of resources are for the uplink response training.

Aspect 5: The method of any of aspects 1 through 4, further comprising: transmitting third signaling indicating a capability of the UE to perform the uplink response training, wherein receiving the first signaling is based at least in part on the capability of the UE to perform the uplink response training.

Aspect 6: The method of any of aspects 1 through 5, wherein receiving the first signaling comprises: receiving the first signaling allocating the first set of resources and a third set of resources for the uplink response training of the one or more hardware components of the UE; and receiving third signaling activating the first set of resources for the uplink response training, wherein performing the uplink response training via the first set of resources is based at least in part on the third signaling.

Aspect 7: The method of aspect 6, wherein the first signaling comprises RRC signaling and the second signaling comprises DCI or a MAC-CE.

Aspect 8: The method of any of aspects 1 through 7, wherein the first set of resources comprises time resources, frequency resources, or both.

Aspect 9: The method of any of aspects 1 through 8, wherein receiving the first signaling comprises: receiving a periodicity associated with the first set of resources, the periodicity comprising a number of slots or a number of symbols, wherein performing the uplink response training via the first set of resources is based at least in part on the periodicity.

Aspect 10: The method of any of aspects 1 through 9, further comprising: transmitting third signaling requesting resources for the uplink response training based at least in part on a trigger condition being satisfied, wherein receiving the first signaling is based at least in part on the third signaling.

Aspect 11: The method of aspect 10, wherein the trigger condition comprises an operating temperature of the UE being above a threshold, a change in operating frequency, or a combination thereof.

Aspect 12: The method of any of aspects 1 through 11, wherein performing the uplink response training comprises: monitoring, while transmitting uplink signaling, a performance metric of a power amplifier of the UE, wherein transmitting the second signaling according to the one or more transmission characteristics comprises: performing a digital pre-distortion operation on the second signaling based at least in part on the performance metric indicating that the power amplifier is operating in a non-linear manner.

Aspect 13: The method of any of aspects 1 through 12, wherein the one or more hardware components comprises an amplifier, a duplexer, an antenna, a filter, an attenuator, a detector, a mixer, or a combination thereof.

Aspect 14: A method for wireless communications at a network entity, comprising: transmitting, to a UE, first signaling allocating a first set of resources for uplink response training of one or more hardware components of the UE, the one or more hardware components comprising a radio frequency chain of the UE; and receiving, from the UE and via a second set of resources, second signaling in accordance with one or more transmission characteristics, the one or more transmission characteristics based at least in part on the uplink response training.

Aspect 15: The method of aspect 14, further comprising: transmitting, to the UE, third signaling indicating one or more radio frequency requirements for the UE.

Aspect 16: The method of aspect 15, wherein the one or more radio frequency requirements comprise a threshold uplink power, a threshold signal quality value, a threshold amount of out-of-band emission, a threshold amount of in-band emission, or a combination thereof.

Aspect 17: The method of any of aspects 14 through 16, wherein the first signaling comprises one or more bits, and logic values of the one or more bits indicate that the first set of resources are for the uplink response training.

Aspect 18: The method of any of aspects 14 through 17, further comprising: receiving third signaling indicating a capability of the UE to perform the uplink response training, wherein transmitting the first signaling is based at least in part on the capability of the UE to perform the uplink response training.

Aspect 19: The method of any of aspects 14 through 18, wherein transmitting the first signaling comprises: transmitting the first signaling allocating the first set of resources and a third set of resources for the uplink response training of the one or more hardware components of the UE; and transmitting third signaling activating the first set of resources for the uplink response training, wherein receiving the second signaling is based at least in part on the third signaling.

Aspect 20: The method of aspect 19, wherein the first signaling comprises RRC signaling and the second signaling comprises DCI or a MAC-CE.

Aspect 21: The method of any of aspects 14 through 20, wherein transmitting the first signaling comprises: transmitting, to a group of UEs that are located within a cell associated with the network entity, the first signaling allocating the first set of resources for the uplink response training, wherein the group of UEs comprise the UE.

Aspect 22: The method of any of aspects 14 through 21, wherein the first set of resources comprises time resources, frequency resources, or both.

Aspect 23: The method of any of aspects 14 through 22, wherein transmitting the first signaling comprises: transmitting a periodicity associated with the first set of resources, the periodicity comprising a number of slots or a number of symbols.

Aspect 24: The method of any of aspects 14 through 23, further comprising: receiving third signaling requesting resources for the uplink response training based at least in part on a trigger condition being satisfied, wherein transmitting the first signaling is based at least in part on the third signaling.

Aspect 25: The method of aspect 24, wherein the trigger condition comprises an operating temperature of the UE being above a threshold, a change in operating frequency, or a combination thereof.

Aspect 26: The method of any of aspects 14 through 25, wherein the one or more hardware components comprises an amplifier, a duplexer, an antenna, a filter, an attenuator, a detector, a mixer, or a combination thereof.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, first signaling allocating a first set of resources for uplink response training of one or more hardware components of the UE, the one or more hardware components comprising a radio frequency chain of the UE;
perform, via the first set of resources and based at least in part on the first signaling, the uplink response training of the one or more hardware components of the UE; and
transmit, to the network entity and via a second set of resources, second signaling in accordance with one or more transmission characteristics, the one or more transmission characteristics based at least in part on the uplink response training.

2. The UE of claim 1, wherein the one or more processors are individually or collectively further operable to execute the code to cause the UE to:
receive, from the network entity, third signaling indicating one or more radio frequency requirements for the UE, wherein the UE performs the uplink response training without applying at least one radio frequency requirement of the one or more radio frequency requirements.

3. The UE of claim 2, wherein the one or more radio frequency requirements comprise a threshold uplink power, a threshold signal quality value, a threshold amount of out-of-band emission, a threshold amount of in-band emission, or a combination thereof.

4. The UE of claim 1, wherein:
the first signaling comprises one or more bits, and
logic values of the one or more bits indicate that the first set of resources are for the uplink response training.

5. The UE of claim 1, wherein the one or more processors are individually or collectively further operable to execute the code to cause the UE to:
transmit third signaling indicating a capability of the UE to perform the uplink response training, wherein receiving the first signaling is based at least in part on the capability of the UE to perform the uplink response training.

6. The UE of claim 1, wherein, to receive the first signaling, the one or more processors are individually or collectively operable to execute the code to cause the UE to:
receive the first signaling allocating the first set of resources and a third set of resources for the uplink response training of the one or more hardware components of the UE; and
receive third signaling activating the first set of resources for the uplink response training, wherein performing the uplink response training via the first set of resources is based at least in part on the third signaling.

7. The UE of claim 6, wherein the first signaling comprises radio resource control signaling and the second signaling comprises downlink control information or a medium access control control element.

8. The UE of claim 1, wherein the first set of resources comprises time resources, frequency resources, or both.

9. The UE of claim 1, wherein, to receive the first signaling, the one or more processors are individually or collectively operable to execute the code to cause the UE to:
receive a periodicity associated with the first set of resources, the periodicity comprising a number of slots or a number of symbols, wherein performing the uplink response training via the first set of resources is based at least in part on the periodicity.

10. The UE of claim 1, wherein the one or more processors are individually or collectively further operable to execute the code to cause the UE to:
transmit third signaling requesting resources for the uplink response training based at least in part on a trigger condition being satisfied, wherein receiving the first signaling is based at least in part on the third signaling.

11. The UE of claim 10, wherein the trigger condition comprises an operating temperature of the UE being above a threshold, a change in operating frequency, or a combination thereof.

12. The UE of claim 1, wherein, to perform the uplink response training, the one or more processors are individually or collectively operable to execute the code to cause the UE to:
monitor, while transmitting uplink signaling, a performance metric of a power amplifier of the UE, wherein transmitting the second signaling according to the one or more transmission characteristics comprises:
perform a digital pre-distortion operation on the second signaling based at least in part on the performance metric indicating that the power amplifier is operating in a non-linear manner.

13. The UE of claim 1, wherein the one or more hardware components comprises an amplifier, a duplexer, an antenna, a filter, an attenuator, a detector, a mixer, or a combination thereof.

14. A network entity, comprising:
one or more memories storing processor-executable code; and
one or more processors coupled with the one or more memories and individually or collectively operable to execute the code to cause the network entity to:
transmit, to a user equipment (UE), first signaling allocating a first set of resources for uplink response training of one or more hardware components of the UE, the one or more hardware components comprising a radio frequency chain of the UE; and
receive, from the UE and via a second set of resources, second signaling in accordance with one or more transmission characteristics, the one or more transmission characteristics based at least in part on the uplink response training.

15. The network entity of claim 14, wherein the one or more processors are individually or collectively further operable to execute the code to cause the network entity to:
transmit, to the UE, third signaling indicating one or more radio frequency requirements for the UE.

16. The network entity of claim 15, wherein the one or more radio frequency requirements comprise a threshold uplink power, a threshold signal quality value, a threshold amount of out-of-band emission, a threshold amount of in-band emission, or a combination thereof.

17. The network entity of claim 14, wherein:
the first signaling comprises one or more bits, and
logic values of the one or more bits indicate that the first set of resources are for the uplink response training.

18. The network entity of claim 14, wherein the one or more processors are individually or collectively further operable to execute the code to cause the network entity to:
receive third signaling indicating a capability of the UE to perform the uplink response training, wherein transmitting the first signaling is based at least in part on the capability of the UE to perform the uplink response training.

19. The network entity of claim 14, wherein, to transmit the first signaling, the one or more processors are individually or collectively operable to execute the code to cause the network entity to:
transmit the first signaling allocating the first set of resources and a third set of resources for the uplink response training of the one or more hardware components of the UE; and
transmit third signaling activating the first set of resources for the uplink response training, wherein receiving the second signaling is based at least in part on the third signaling.

20. The network entity of claim 19, wherein the first signaling comprises radio resource control signaling and the second signaling comprises downlink control information or a medium access control control element.

21. The network entity of claim 14, wherein, to transmit the first signaling, the one or more processors are individually or collectively operable to execute the code to cause the network entity to:
transmit, to a group of UEs that are located within a cell associated with the network entity, the first signaling allocating the first set of resources for the uplink response training, wherein the group of UEs comprise the UE.

22. The network entity of claim 14, wherein the first set of resources comprises time resources, frequency resources, or both.

23. The network entity of claim 14, wherein, to transmit the first signaling, the one or more processors are individually or collectively operable to execute the code to cause the network entity to:
transmit a periodicity associated with the first set of resources, the periodicity comprising a number of slots or a number of symbols.

24. The network entity of claim 14, wherein the one or more processors are individually or collectively further operable to execute the code to cause the network entity to:
receive third signaling requesting resources for the uplink response training based at least in part on a trigger condition being satisfied, wherein transmitting the first signaling is based at least in part on the third signaling.

25. The network entity of claim 24, wherein the trigger condition comprises an operating temperature of the UE being above a threshold, a change in operating frequency, or a combination thereof.

26. The network entity of claim 14, wherein the one or more hardware components comprises an amplifier, a duplexer, an antenna, a filter, an attenuator, a detector, a mixer, or a combination thereof.

27. A method for wireless communications at a user equipment (UE), comprising:
receiving, from a network entity, first signaling allocating a first set of resources for uplink response training of one or more hardware components of the UE, the one or more hardware components comprising a radio frequency chain of the UE;
performing, via the first set of resources and based at least in part on the first signaling, the uplink response training of the one or more hardware components of the UE; and
transmitting, to the network entity and via a second set of resources, second signaling in accordance with one or more transmission characteristics, the one or more transmission characteristics based at least in part on the uplink response training.

28. The method of claim 27, further comprising:
receiving, from the network entity, third signaling indicating one or more radio frequency requirements for the UE, wherein the UE performs the uplink response training without applying at least one radio frequency requirement of the one or more radio frequency requirements.

29. A method for wireless communications at a network entity, comprising:
transmitting, to a user equipment (UE), first signaling allocating a first set of resources for uplink response training of one or more hardware components of the UE, the one or more hardware components comprising a radio frequency chain of the UE; and
receiving, from the UE and via a second set of resources, second signaling in accordance with one or more transmission characteristics, the one or more transmission characteristics based at least in part on the uplink response training.

30. The method of claim 29, further comprising:
transmitting, to the UE, third signaling indicating one or more radio frequency requirements for the UE.
